(19) United States
(12) Patent Application Publication
(10) Pub. No.: US 2011/0048133 A1
(43) Pub. Date: Mar. 3, 2011

(54) VIBRATION ELEMENT COUPLED WITH NON-LINEAR FORCE TO IMPROVE NON-RESONANT FREQUENCY RESPONSE

(75) Inventors: Ji-Tzuoh Lin, Louisville, KY (US); Bruce Alphenaar, Louisville, KY (US)

(73) Assignee: UNIVERSITY OF LOUISVILLE RESEARCH FOUNDATION, INC., Louisville, KY (US)

(21) Appl. No.: 12/871,524

(22) Filed: Aug. 30, 2010

Related U.S. Application Data
(60) Provisional application No. 61/238,422, filed on Aug. 31, 2009.

(51) Int. Cl. G01P 15/09

(52) U.S. Cl. 73/514.34

(57) ABSTRACT

Embodiments of the invention couple a non-linear force to a vibration element such as a piezoelectric cantilever to introduce chaotic, i.e., non-resonant vibration in the vibration element and thereby improve the non-resonant response of the vibration element. By doing so, the vibration element is responsive to a wider frequency range of vibrations and thus may be more efficient in scavenging energy in environments where the vibration frequency is not constant, e.g., in environment subject to multi-mode or random vibration sources.

### CROSS-REFERENCE TO RELATED APPLICATIONS

This application claims priority to U.S. Patent Provisional Application Ser. No. 61/238,422 to Ji-Tzuoh Lin et al. entitled “LINEAR VIBRATION ELEMENT COUPLED WITH NON-LINEAR FORCE TO IMPROVE NON-RESONANT FREQUENCY RESPONSE” and filed on Aug. 31, 2009, which application is incorporated by reference herein.

### GOVERNMENT RIGHTS

The invention was supported in whole or in part by Contract/Grant No. DE-FC26-06NT42795 from the Department of Energy and Contract/Grant No. DAAB07-03-D-B010/TO-0198 from the United States Navy. The Government has certain rights in the invention.

### FIELD OF THE INVENTION

The present invention relates to energy harvesting and vibration sensing, and in particular, to harvesting energy or otherwise generating an electrical signal responsive to a source of vibration.

### BACKGROUND OF THE INVENTION

Scavenging energy from background mechanical vibrations in the environment has been proposed as a possible method to provide power in situations where battery usage is impractical or inconvenient. Proposed energy scavenging techniques for generating power including generating energy from the vibrations of a linear vibration element such as a piezoelectric cantilever, as well as electromagnetic inductive coupling and charge pumping across vibrating capacitive plates.

With respect to piezoelectric cantilever-based designs, for example, it has been shown that a piezoelectric cantilever attached to a vibrating structure can be used to power wireless transmission nodes for sensing applications. However, in order to generate sufficient power, the frequency of the vibration source typically must match the resonant frequency of the piezoelectric cantilever. If the source vibrates at a fixed, known frequency, the dimensions of the cantilever, and the proof mass can be adjusted to ensure frequency matching.

However, many naturally occurring vibration sources do not have a fixed frequency of vibration, and vibrate over a broad spectrum of frequencies. Lack of coupling of the piezoelectric cantilever to the off-resonance vibrations means that only a small amount of the available power can be scavenged. For example, in many natural environments in which energy scavenging could be utilized, e.g., roadways or bridges subject to vehicle traffic, oceans or other bodies of water subject to waves and currents, vibrations are random and/or are spread over a broad spectrum of frequencies.

It has been proposed to modify the response characteristics of a piezoelectric cantilever by applying a controlled external force to the cantilever to tune the resonant frequency of the cantilever to the frequency of a vibration source. By doing so, at least in principle, a piezoelectric cantilever could be actively tuned to match the maximum vibrational output of the environment at any particular time, and thereby maximize the amount of power scavenged. It is expected, however, that the power consumed by active tuning would completely offset any improvement obtained in the scavenging efficiency.

It has also been proposed to utilize a passive tuning scheme in which a fixed force modifies the frequency response of the cantilever beam, without requiring additional power input. For example, an attractive magnetic force acting above the cantilever beam reduces the spring constant of the cantilever and lowers the resonance frequency, while an attractive force acting along the axis of the cantilever applies axial tension, and increases the resonance frequency. Both of the cases above happen only within the linear dynamic range. However, while such an approach could effectively tune a cantilever to a specific resonant frequency, the magnetic force would dampen the cantilever motion and reduce the resulting power output. Furthermore, as the force is fixed, the resonant frequency of the cantilever would likewise be fixed, and thus the scavenging efficiency would be limited in instances where the vibration source was not fixed at a specific frequency.

Therefore, a need exists in the art for a manner of improving the energy scavenging efficiency of a piezoelectric cantilever or other type of vibration element over a larger range of frequencies.

### SUMMARY OF THE INVENTION

Embodiments of the invention address these and other problems associated with the prior art by coupling a non-linear force to a vibration element such as a piezoelectric cantilever to introduce non-linear dynamics such as chaotic (i.e., non-resonant), sub-harmonic, and amplifying vibration in the vibration element and thereby improve the overall non-resonant response of the vibration element. By doing so, the vibration element is responsive to a wider frequency range of vibrations and is thus more efficient in scavenging energy in environments where the vibration frequency is not constant, e.g., in environment subject to multi-mode or random vibration sources.

In one embodiment consistent with the invention, a vibration element such as a piezoelectric cantilever is subject to a non-linear force such as a static magnetic field. For example, a permanent neodymium magnet may be fixed to the end of a piezoelectric cantilever, causing it to experience a non-linear force as it moves with respect to a stationary magnet positioned proximate to the cantilever. By virtue of the static magnetic field, the magnetically coupled cantilever responds to vibration over a much broader frequency range than a conventional cantilever, and exhibits non-periodic or chaotic motion. The off-resonance response of the cantilever is improved, and often without any appreciable reduction in the response at the resonant frequency.

Therefore, consistent with one aspect of the invention, an apparatus includes a vibration element having a resonant frequency, wherein the vibration element is coupled to a non-linear force that improves a response of the vibration element to non-resonant vibrations; and a circuit coupled to the vibration element and configured to output an electrical signal in response to vibration of the vibration element.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1(a) is a block diagram of an experimental set up for a single piezoelectric cantilever energy scavenging device consistent with the invention.

FIG. 1(b) is a circuit diagram of a circuit used in the device of FIG. 1(a) to transfer an AC piezoelectric cantilever voltage (Vᵢₙ) into a measured DC output voltage (Vₒᵤₜ).

FIG. 1(c) is a block diagram of an experimental set up for a double piezoelectric cantilever energy scavenging device consistent with the invention.

FIG. 2(a) is a graph of an exemplary output of the piezoelectric cantilever in the single cantilever device of FIG. 1(a) as a function of shaker table frequency, with and without magnetic coupling being present.

FIG. 2(b) is a graph of an exemplary output of the piezoelectric cantilever in the double cantilever device of FIG. 1(c) as a function of shaker table frequency, with and without magnetic coupling being present.

FIG. 2(c) is a graph illustrating the integration of the output of the single cantilever device of FIG. 1(a) as a function of frequency.

FIG. 2(d) is a graph illustrating the integration of the output of the double cantilever device of FIG. 1(c) as a function of frequency.

FIG. 3(a) is a block diagram of a modified one-dimensional spring force model of the device of FIG. 1(a), showing the parameters used to simulate cantilever motion.

FIG. 3(b) is a block diagram of an experimental set up for obtaining an empirical measure of the magnetic force in the z-direction for the device of FIG. 1(a).

FIG. 4(a) is a graph of magnetic force for the device of FIG. 1(a) as a function of cantilever deflection measured using the apparatus shown in FIG. 3(b) for three different magnet separation distances (4 mm, 5 mm and 10 mm), as well as the spring force of the cantilever.

FIG. 4(b) is a graph of spring potential (dashed line) and the potential due to the combination of the restoring force and the magnetic force for the 3 magnet separation distances in FIG. 4(a).

FIG. 5 is a graph of a simulated output of the cantilever of the device of FIG. 1(a) for the case of no magnetic coupling (dashed line) and magnetic coupling (solid line), with a magnet separation distance of about 5 mm and an acceleration of about 7 m/s².

FIG. 6(a) is a circuit diagram of a circuit for performing an open circuit measurement on Vₚₚ directly from the piezoelectric cantilever in the device of FIG. 1(a).

FIG. 6(b) is a graph of the voltage Vpp over time with and without magnetic coupling measured with the circuit of FIG. 6(a) in “pink” background noise, with a higher swing voltage reflecting the voltage generated by coupling setup with larger cantilever motions.

FIG. 7(a) is a circuit diagram of a rectified circuit with a resistor coupled across the output for measuring a DC voltage output of the device of FIG. 1(a).

FIG. 7(b) is a graph of the output voltage V with and without magnetic coupling measured with the circuit of FIG. 7(a) in “pink” background noise, with the fluctuations of the voltage indicating the increased power generated by a magnetic coupled cantilever.

FIG. 8(a) is a circuit diagram of a storage circuit for measuring a DC voltage output of the device of FIG. 1(a).

FIG. 8(b) is a graph of the output voltage V with and without magnetic coupling measured with the circuit of FIG. 8(a) in “pink” background noise, indicating that more charge is stored with a magnetic coupling setup.

FIG. 9 is a graph of the magnitude of magnetic forces, spring forces and resultant forces exerted on the cantilever of the device of FIG. 1(a).

FIG. 10 is a graph of the integration of the measured forces from FIG. 9, representing the magnetic potential, spring potential and the resultant spring potential therefor.

FIG. 11 is a graph of an exemplary peak to peak voltage output of an exemplary test set up as a function of shaker table frequency, using the circuit shown in FIG. 6(a) with and without magnetic coupling being present.

FIG. 12 is a graph of a theoretical calculation of the predicted power output of the exemplary test set up used in FIG. 11.

FIG. 13(a) is a graph of an exemplary peak to peak voltage output of the exemplary test set up used in FIG. 11, in response to a 6.5 Hz source of vibration.

FIG. 13(b) is a graph of a theoretical calculation of the predicted peak to peak voltage output of the exemplary test set up used in FIG. 11, in response to a 6.5 Hz source of vibration.

FIG. 13(c) is a Poincaré plot graph showing the evolution of velocity and voltage output for the exemplary test set up used in FIG. 11, in response to a 6.5 Hz source of vibration.

FIG. 13(d) is a spectrum analysis graph of the exemplary test set up used in FIG. 11, in response to a 6.5 Hz source of vibration with the magnetic coupling being present.

FIGS. 14(a)-14(d) are graphs corresponding to the graphs in FIGS. 13(a)-13(d) for the exemplary test set up used in FIG. 11, but in response to a 9.5 Hz source of vibration.

FIGS. 15(a)-15(d) are graphs corresponding to the graphs in FIGS. 13(a)-13(d) for the exemplary test set up used in FIG. 11, but in response to a 13 Hz source of vibration.

FIGS. 16(a)-16(d) are graphs corresponding to the graphs in FIGS. 13(a)-13(d) for the exemplary test set up used in FIG. 11, but in response to a 16 Hz source of vibration.

FIGS. 17(a)-17(d) are graphs corresponding to the graphs in FIGS. 13(a)-13(d) for the exemplary test set up used in FIG. 11, but in response to a 20 Hz source of vibration.

FIGS. 18(a) and 18(b) are graphs of exemplary outputs from the test set up used in FIGS. 1(a) and 1(b), using a source of vibration that provides an acceleration that is above (FIG. 18(a)) and below (FIG. 18(b)) a coupling threshold for the exemplary test set up.

FIG. 19 is a graph of voltage output vs. acceleration for the exemplary test set up used in FIGS. 1(a) and 1(b), and using a 4.8 mm magnet.

FIGS. 20(a) and 20(b) are graphs of voltage output vs. acceleration for the exemplary test set up used in FIGS. 1(a) and 1(b), and using 1.6 mm (FIG. 20(a)) and 1.0 mm (FIG. 20(b) magnets.

FIG. 21 is a graph of the resultant forces of the uncoupled and coupled cantilever in the exemplary test set up of FIG. 11 with different sizes of magnets.

FIG. 22 is a graph of the potentials of the uncoupled and coupled cantilever in the exemplary test set up used in FIG. 11 with different sizes of magnets.

FIG. 23 is a graph illustrating the correspondence of experimental and theoretical results of acceleration thresholds vs. magnet size for the exemplary test set up used in FIG. 11.

FIGS. 24(a), 24(b) and 24(c) are graphs of an exemplary output of the piezoelectric cantilever in the device of FIGS. 1(a) and 1(b) as a function of shaker table frequency, respectively with 4.8 mm, 1.6 mm and 1.0 mm, but with the same acceleration, and illustrating a higher output but narrower frequency range for larger magnets around the resonant frequency of the cantilever responsive to the same acceleration.

It should be understood that the appended drawings are not necessarily to scale, presenting a somewhat simplified representation of various features illustrative of the basic principles of embodiments of the invention. The specific design features of embodiments of the invention as disclosed herein, including, for example, specific dimensions, orientations, locations, and shapes of various illustrated components, as well as specific sequences of operations (e.g., including concurrent and/or sequential operations), will be determined in part by the particular intended application and use environment. Certain features of the illustrated embodiments may have been enlarged or distorted relative to others to facilitate visualization and clear understanding.

### DETAILED DESCRIPTION

Embodiments consistent with the invention couple or expose a linear vibration element to a non-linear force to cause chaotic, or non-resonant vibration in the linear vibration element, and thereby improve the frequency response of the linear vibration element to non-resonant frequencies. In addition, it is desirable in many embodiments to provide a non-linear force that is symmetrically and bi-directionally applied to the linear vibration element such that the non-linear force is balanced between the positive and negative displacement of the linear vibration element, providing substantially no bias toward either direction of displacement that could otherwise dampen the response of the linear vibration element at its resonant frequency. The non-linear force also introduces amplifying ultra-harmonic and enhanced sub-harmonic components of the resonant frequency

A vibration element within the context of the invention may include various types of devices that generate energy in response to a vibrational input, including various devices with linear responses that generate electrical current via piezoelectric, capacitive, electromagnetic and electrostatic effects. In addition, a vibration element may include various mechanical configurations through which movement is generated in response to a vibration, e.g., cantilevers, pendulums, opposing plates, etc. While in the illustrated embodiments below the vibration element is a linear vibration element, in other embodiments, non-linear vibration elements may be used. For example, a non-linear vibration element may include various mechanical configurations that exhibit non-linear response characteristics, e.g., based upon the use of compound springs, springs made of piezoelectric material or springs made of magnetic material. In the embodiments discussed below, a linear vibration element, implemented as a piezoelectric cantilever, is used; however, it will be appreciated that the invention is not limited to such devices.

A non-linear force within the context of the invention may include various forces that may be applied to a vibration element by virtue of a coupling of the vibration element, or a component mechanically secured to the vibration element, and another element disposed in proximity to the vibration element. In the illustrated embodiments, for example, a magnetic force, e.g., as generated by the magnetic coupling of a first magnet coupled to the piezoelectric cantilever and a second magnet disposed in proximity thereto, is utilized to apply a non-linear force to the piezoelectric cantilever. However, it will be appreciated that other sources of non-linear forces, e.g., other magnetic fields, electromagnetic fields, and electrostatic fields, may be used in the alternative.

It will also be appreciated that the principles of the invention may be applied in connection with energy harvesting from a wide variety of vibration sources, including, for example, pink noise vibration sources, bridges, roadways, buoys, waves, water currents, fences, streetlights, enclosures, etc., as well as vibration sources exhibiting random vibrations, fixed frequency vibrations, controlled scanning spectrum vibrations, broad band vibrations, etc.

As will be discussed in greater detail below, in the illustrated embodiment, a bi-directional and symmetric non-linear force is applied to a cantilever by orienting pairs of permanent magnets in a repelling and face-to-face orientation to one another along an axis of a cantilever, with one magnet disposed proximate an end of the cantilever and the other magnet disposed either on a fixed support or proximate an end of a second cantilever disposed generally along the same axis as the other cantilever. It will be appreciated, however, that a non-linear force may be applied in other manners consistent with the invention. For example, other orientations of magnets may be used, including orienting magnets in an attractive orientation, orienting magnets at other relative angles to one another and/or to the cantilever axis, or using multiple fixed and/or cantilever-mounted magnets. As one example, it may be desirable to utilize multiple fixed magnets on opposing sides of a cantilever to apply balanced attractive or repulsive forces to a cantilever-mounted magnet. It is believed that by applying non-linear forces bi-directionally and symmetrically to a vibration element, dampening of the response of the vibration element at its resonant frequency is minimized.

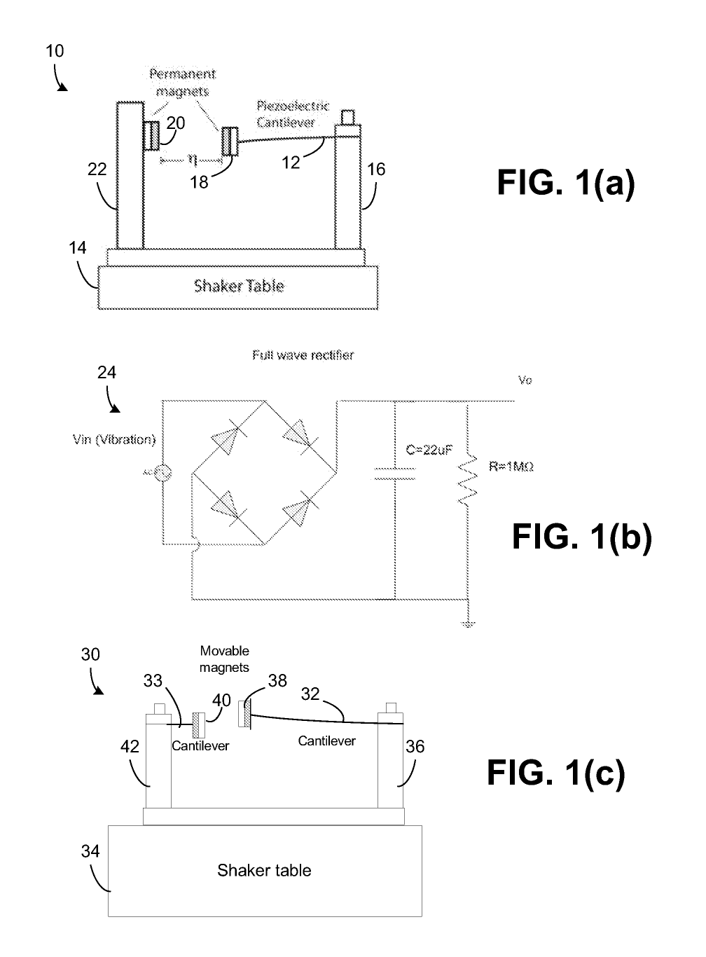

Turning now to the Drawings, wherein like numbers denote like parts throughout the several views, FIG. 1(a) illustrates an exemplary test set up for an energy scavenging device 10 incorporating as a linear vibration element a piezoelectric cantilever 12. Device 10 is illustrated as disposed on a shaker table 14. Cantilever 12 is coupled at one end to a support 16 that orients the cantilever in a generally horizontal orientation, or more generally in an orientation that is generally perpendicular to the vibration direction.

In this embodiment, cantilever 12 is subjected to a non-linear force taking the form of a magnetic force oriented along the cantilever axis, incorporating a pair of permanent magnets 18, 20 facing one another separated by a distance 11. By orienting the non-linear force along the cantilever axis, the frequency response of the piezoelectric cantilever can be substantially altered in a way that provides an effective method to harvest off-resonance vibrations, without altering the resonant frequency of the cantilever or dampening the response at the resonant frequency. Instead, the response is broadened by the appearance of non-periodic oscillations outside of the resonance condition, thus improving the response to off-resonance vibrations, and increasing the output of the piezoelectric cantilever for random or broadband vibration sources.

The following working examples illustrate various experiments and simulations performed using the basic configuration illustrated in FIG. 1(a), as well as various modifications that may be made to such a configuration to alter the energy scavenging capabilities of the device in different environments. It will be appreciated that the invention is not limited to these particular modifications and configurations.

### Working Example 1

### Single and Double Cantilevers

A test set up configured in the manner illustrated above in connection with FIGS. 1(a) and 1(b) was constructed. Cantilever 12 was manufactured using commercially available unimorph piezoelectric discs composed of an about 0.09 mm thick PZT layer deposited on an about 0.1 mm thick brass shim (APC International, MFT-50T-1.9A1). The disc was cut into an about 13 mm wide by about 50 mm long strip, and clamped at one end to produce an about 44 mm long cantilever. The PZT layer extended about 25 mm along the length of the cantilever, and the remainder was composed only of brass. The proof mass (including the magnet and an additional fixture that holds the magnet) weighed about 2.4 gm, while the cantilever itself weighed about 0.8 gm. The electrical leads were soldered with thin lead wires (134 AWP, Vishay) to the top side of the PZT and the bottom side of the shim.

Vibration was generated by a shaker table 14 (Labwork ET-126) powered by an amplified sinusoidal wave using a Yokogawa EG300 function generator and a Labwork Pa-13 amplifier. A custom Labview data acquisition program was used to measure output voltage from the cantilever beam. Magnets 18, 20 were implemented as about 4.8 mm diameter disc-shaped rare earth magnets (Radio Shack model 64-1895), with one magnet 18 attached to the vibrating tip of cantilever 12, and the other magnet 20 attached directly to a vertical support 22 on the shaker table frame.

In all measurements, the shaker table acceleration was set to approximately 7 m/s², and the frequency swept from 0 to 30 Hz in 0.5 Hz steps. The voltage generated by the piezoelectric cantilever beam was rectified, and detected across a 22 μF capacitor and 1 M Ohm resistor in parallel, using circuit 24 shown in FIG. 1(b). The resonance frequency of the cantilever beam with its proof mass was measured to be approximately 10.4 Hz. The opposing magnet fitted at the free end of the cantilever supplied a symmetrical, repulsive force about the balance of the cantilever during vibration. The horizontal separation between the magnets (designated by η) was adjusted to be approximately η=5 mm. This separation was found to provide good compensation for the spring force, and minimized the effective restoring force near the equilibrium point.

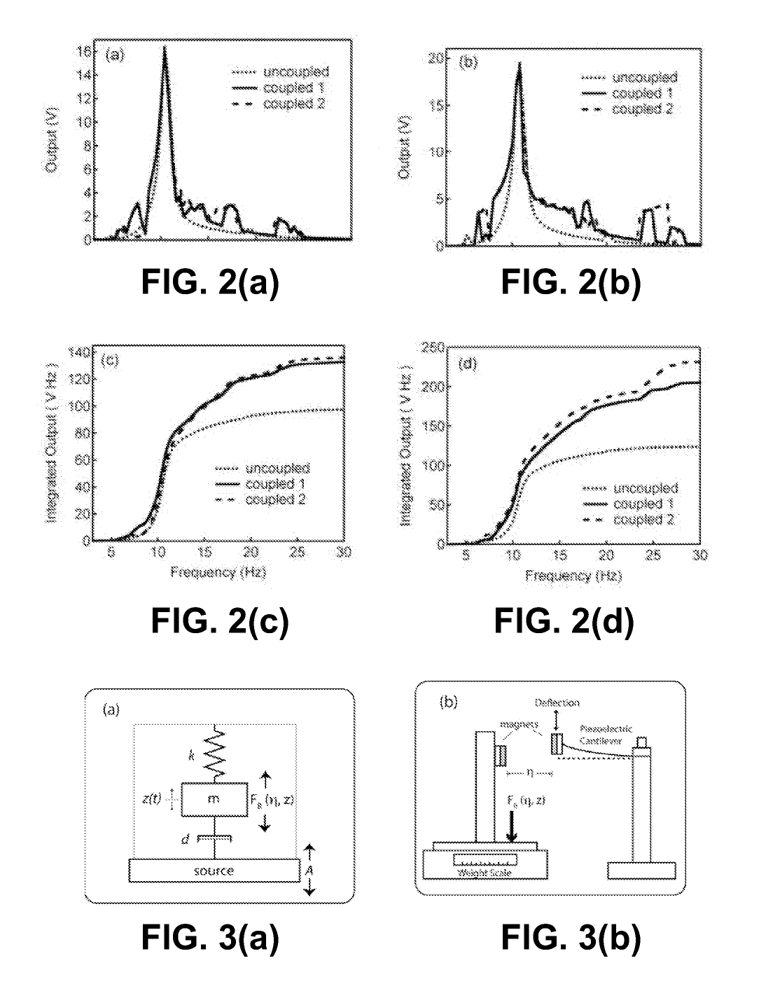

FIG. 2(a) shows the output of the cantilever as a function of shaker table vibration frequency for the case where the opposing magnet is fixed to the shaker table. The results from two measurement runs in the coupled state are shown, together with the output of the cantilever measured in the uncoupled state. (This is obtained by removing the opposing magnet.) At the resonance frequency, the output of the cantilever exceeded 16 V, and the peak height, resonance frequency and line width are all approximately the same for the coupled and un-coupled states. On either side of the main resonance, however, there is additional output observed for the coupled cantilever, which is not observed in the uncoupled state. As can be seen from a comparison of the two coupled runs, the frequency distribution of the peaks is not completely reproducible, although there is a reproducibility in the overall pattern of the output. The motion of the cantilever in the off resonance condition is aperiodic.

Also measured was a double cantilever system, e.g., as shown in FIG. 1(c), in which the second magnet was connected to an opposing cantilever (having resonant frequency higher than 60 Hz) rather than to a fixed point. In particular, unlike device 10 of FIG. 1(a), FIG. 1(c) utilizes an energy scavenging device 30 incorporating dual cantilevers 32, 33, with cantilever 32 implemented as a piezoelectric cantilever operating as a linear vibration element. Device 30 is illustrated as disposed on a shaker table 34. Cantilever 32 is coupled at one end to a support 36 that orients the cantilever in a generally horizontal orientation, or more generally in an orientation that is generally perpendicular to the vibration direction. In this embodiment, cantilever 32 is subjected to a non-linear force taking the form of a magnetic force oriented along the cantilever axis, incorporating a pair of permanent magnets 38, 40 facing one another. Unlike magnet 20 of device 10, however, magnet 40 is disposed on cantilever 33 disposed on a support generally parallel to the direction of vibration.

As shown in FIG. 2(b), the results for the double cantilever system of FIG. 1(c) were similar to the single cantilever system, except that the double cantilever system showed a larger overall increase in off-resonance output.

The overall improvement in the harvesting efficiency can be illustrated by plotting the integrated voltage output of the cantilever beam as a function of frequency. For both the single (FIG. 2 (c)) and double (FIG. 2 (d)) cantilever systems, the total output over the 0-30 Hz bandwidth showed a substantial increase in the coupled versus the uncoupled case. The total improvement was about 35%-87%, with some variation between measurement runs.

To calculate the amplitude of the cantilever deflection in the presence of the magnetic coupling force, a modified version of the standard spring-mass model may be used, the parameters of which are illustrated in FIG. 3(a). The cantilever may be represented by a one-dimensional springmass system, where m is the proof mass, and k is the spring constant. The cantilever deflection, z(t), is driven by a vibrating source, which oscillates sinusoidally with an acceleration A and angular frequency ω. Electrical and parasitic damping, bₑ and bₘ, may be considered together as a single damping coefficient, d. To minimize the complexity of the problem, the magnetic coupling force F_{B}, may be considered to be one-dimensional, acting only in the z-direction. The deflection z(t) can then be determined by solving the differential equation for a one-dimensional forced harmonic oscillator, combined with an unknown non-linear force:

m\ddot{z}+dż+kz+F_{B}(z,η)=mA cos(ωt) (1)

In general, the magnetic coupling force F_{B}(z, η) is a complicated non-linear function of the deflection z and the magnet/magnet separation distance, η. However, for a given value of η, the force component in the z-direction may be determined experimentally by measuring the weight change of the cantilever under manual deflection. FIG. 3 (b) shows the experimental set-up for the force determination. The opposing magnet was mounted onto a weighing scale, and the separation between the magnets η was measured at the balance point (z=0) when the magnets were in line with each other. The position of the magnetized cantilever was then manipulated by pushing up and down at the end of a cantilever beam, simulating flexure movement. The deflection z was measured using a micrometer, while the reading on the scale provided the force between the two magnets. The cantilever's restoring force was determined independently by setting the cantilever on the weighing scale, deflecting the cantilever, and recording the weight/deflection relationship.

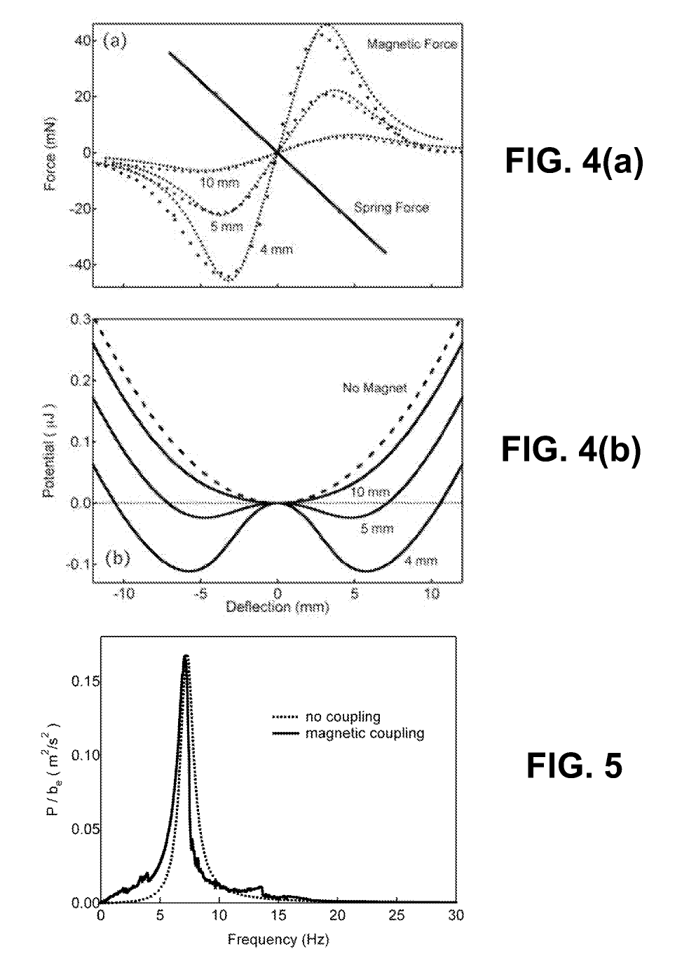

The magnetic forces F_{B} (z, η) determined for three different magnet separation distances 11 are plotted in FIGS. 4(a) and 4(b) as a function of the deflection distance z. For all three values of η, two maxima were observed in the magnetic force magnitude, at approximately z=+/−5 mm. This deflection distance was approximately equal to the magnet diameter, and corresponded to the point where the two magnets no longer overlapped each other. The magnitude of the maxima increased rapidly with decreasing η. To aid in calculation, the experimentally determined magnetic force values were fit to an empirically determined analytical expression for F_{B} (z, η):

$${F}_{B} ( z , η ) = \frac{az}{( b + {cz}^{4} )} \qquad ( 2 )$$

where a, b, and c are fitting parameters. As shown in FIG. 5, this ad hoc expression provided a reasonably accurate fit to the magnetic force data. The influence of the magnetic force may be better appreciated by considering the potential energy of the cantilever as a function of deflection distance, as shown in FIG. 4(a). The potential energy is determined by integrating over the total force (magnetic force plus restoring force), where the analytical expression for the magnetic force (given by Eq. (2)) is used. As seen in FIG. 4(b), the magnetic force modified the standard harmonic oscillator potential to include two potential minima, one on either side of the zero deflection point. Since it is equally likely for the cantilever to lie in either of these minimum points, motion between the two minima is possible under relatively low amplitude accelerations and at non-resonance driving frequencies.

Using the analytic expression for the magnetic force, the cantilever displacement z(t) was determined from Eq. (1) using the non-linear differential equation solver provided by Mathematica (Wolfram Research). The voltage output was then modeled by summing over ż(t) calculated at 0.1 second time intervals for a total time of 100 s. The results of this calculation are shown in FIG. 5. In the absence of magnetic coupling, a peak in the output is observed at a resonant frequency of 10.3 Hz. The addition of magnetic coupling produces additional output above and below the resonant frequency, while little change is observed in the resonance peak. This is in qualitative agreement with the experimental observations. The parameters used in the simulation were identical to those used in the experiment.

Therefore, it was shown that power output for a piezoelectric cantilever-based energy scavenging device could be enhanced by applying a repulsive magnetic force to a piezoelectric cantilever beam to compensate the cantilever spring force, and lower the restoring potential on either side of the equilibrium point. For a symmetric magnetic force, the cantilever's resonant frequency and amplitude at the resonant frequency were not altered; however, there was an increase in the off-resonance output. The dynamic between the magnetic and spring forces increased the total voltage generated by the electric cantilever across the scanned frequency spectrum.

### Working Example 2

### Pink Noise Vibration

The set-up of FIG. 1(a) was again used, this time with vibration generated by shaker table 14 driven by an amplified pink noise source. The pink noise was generated numerically, with amplitude and crest factor set to about −4 dB and about 1.41, respectively. The average shaker table acceleration was about 7.5 m/s², independent of the magnetic coupling. A custom Labview data acquisition program measured output voltage from the cantilever beam and the acceleration from the shaker table, once every second. The voltage peak to peak (Vₚₚ) was measured by an oscilloscope (Agilent 54624A), and the dc voltage was detected with a digital multi-meter (YOGOGAWA 7561). An about 4.8 mm diameter round rare earth magnet 18 (Radio Shack model 64-1895) was attached to the vibrating tip of the cantilever beam 12, while a similar opposing magnet 20 was attached directly to the shaker table frame, with repulsive force. The distance between the magnets 11 was adjusted to about 5.5 mm, to make the magnetic force comparable to the spring force of the cantilever.

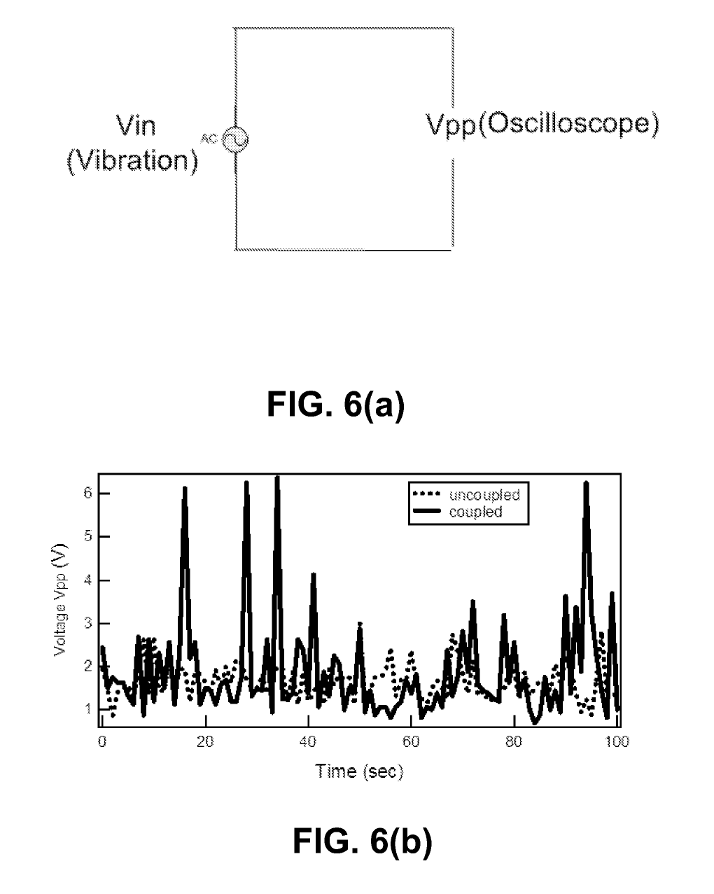

The voltage generated by the cantilever in response to the pink noise source was measured using three different circuits, shown respectively in FIGS. 6(a), 7(a) and 8(a). In each case, the output from the coupled cantilever was compared with the output from the same cantilever in the uncoupled situation (with the opposing magnet removed). In FIG. 6(a), the piezoelectric cantilever beam was wired directly to an oscilloscope with a 1 M Ohm input impedance and the peak-to-peak output voltage, Vₚₚ is measured. As shown in FIG. 6(b), the cantilever output was seen to fluctuate as a function of time, reflecting the random nature of the vibrations. For much of the time, the output from the coupled and uncoupled cantilevers was similar. However, occasionally, very large voltage spikes were observed in the output from the coupled cantilever, that were not observed for the uncoupled case. The voltage peak to peak spanned to about 5.7 V (min. about 0.7 V and max. about 6.4 V) with the coupled setup and only about 2.2 V (min. 0.9 V to max. 3 V) volts with the uncoupled cantilever. The ratio of the maximal voltage output from the coupled to the uncoupled was about 2.1.

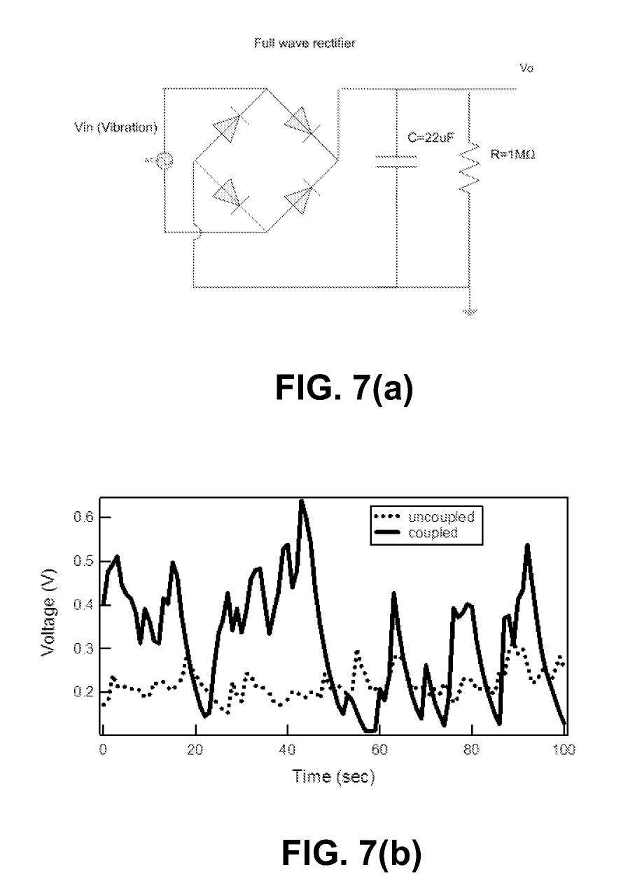

In FIG. 7(a), the voltage generated by the piezoelectric cantilever beam was rectified, and detected across a 22 μF capacitor and a 1 M Ohm resistor in parallel. As shown in FIG. 7(b), the amplitude of the voltage output with this measurement circuit was most of the time higher in the coupled case than in the uncoupled case. This is because the RC decay time of the circuit was larger than the time between the large amplitude deflections of the cantilever. The average voltage measured across the capacitor or the voltage integration over time was approximately 50% higher in the coupled case.

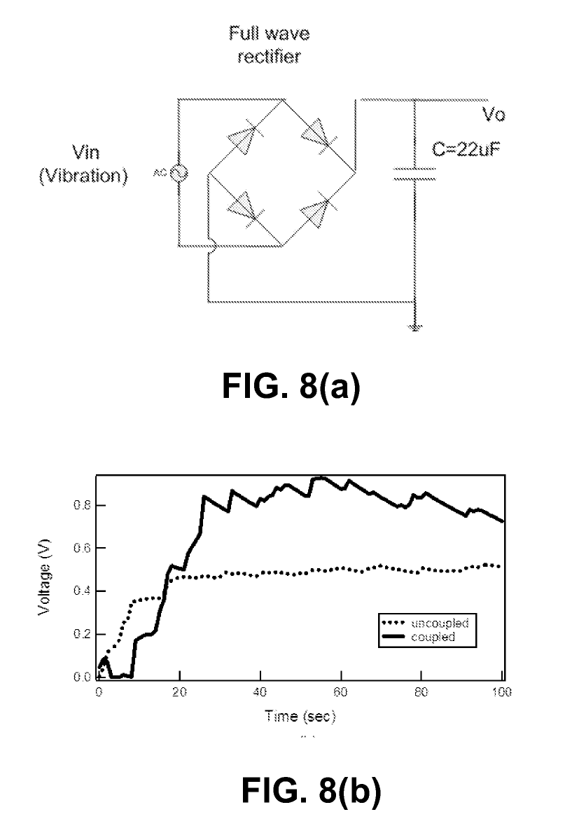

In FIG. 8(a), the rectified voltage was measured directly across the 22 μF capacitor without the 1 M Ohm resistor. As shown in FIG. 8(b), the voltage across the capacitor increased with time, until a maximum charging voltage was achieved. The maximum voltage measured across the capacitor was approximately 50% higher in the coupled case than in the uncoupled case. Note that there was a time delay for the coupled cantilever to achieve a higher voltage than the uncoupled cantilever. This is due to the time passing before the first large amplitude deflection occurred. The random nature of the motion means that this time will typically vary from run to run, however, on average the coupled cantilever output will be consistently higher than the uncoupled output. Note that in addition to producing more power, the higher voltage output enabled circuit operation without a step-up transformer, eliminating the power loss in the transformer.

An empirical measure of the magnetic force was obtained using a similar experimental set-up to that discussed above in connection with FIG. 3(b). The opposing magnet was mounted onto a measurement scale, and the position of the magnetized cantilever was manipulated by pushing up and down at the end of a cantilever beam, simulating flexure movement. The deflection z was measured using a micrometer, while the reading on the scale provided the force between the two magnets. Only the magnetic force in the z direction, F_{z}, contributes to the resultant spring force, so at z=0, the force was zero in the z direction because the two magnetic forces only repelled each other in the longitudinal direction. F_{z} increased as the angles between the two magnets increased until the overlap between the two magnets was zero. At this point, F_{z} decreased with increasing distance because the force is inversely proportional to the distance cubed as seen in eq. (2).

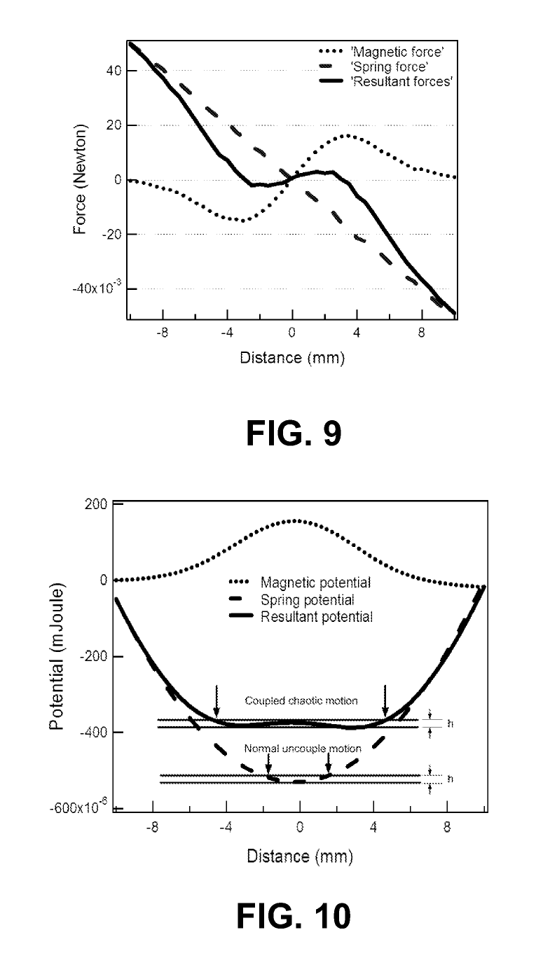

The spring force, the magnetic force and the resultant force (spring plus magnetic) are plotted in FIG. 9. The resultant force was significantly reduced compared to the bare spring force near z=0. The coupled system had three equilibrium points where the resultant force was zero, compared to the single equilibrium point of the bare spring force. Because the resultant force in the region of the three equilibrium points was relatively small, transitions between the three points occurred relatively easily. In FIG. 10 the potential energy is plotted for both the uncoupled and coupled systems. The potential energy is calculated by direct integration of the force with respect to the displacement, z. The resultant potential is raised, with two local minima symmetric to z=0. This double well structure allows easy movement of the cantilever beam even when excited by non resonant forces. Once it passes the local high potential, it drifts to the other side of the balance, resulting in an increased total deflection distance. This can be seen by considering the possible motion of the cantilever beam having a kinetic energy, h, which is large enough to surmount the potential barrier at z=0. With the same random acceleration background the coupled cantilever can travel further distance than the uncoupled one. The voltage output, which depends on the movement of the cantilever, therefore, increases. The ratio of the maximum displacement in the coupled and uncoupled systems determined from FIG. 10 was about 2.4. This was comparable to the ratio of maximum voltage output in the coupled and uncoupled systems, which as seen in FIG. 6(b), was about 2.1.

It is believed that magnetic coupling (although a passive force requiring no energy) introduces a symmetric force which acts in the opposite direction to the spring force around z=0. Being comparable in magnitude to the spring force, the magnetic force compensates the spring potential, and introduces a double valley in the potential energy profile. Under the influence of the modified spring potential, the magnetically coupled cantilever responds to a random vibration source (like pink noise) by moving chaotically between the two minima in the potential energy profile. As compared with the non-chaotic motion of the uncoupled cantilever around the single z=0 potential minimum, this produces larger cantilever deflection and more voltage output from the piezoelectric cantilever. The oscillations around the resonance frequency are unstable and chaotic, but persistent. The modified spring potential is higher, and flatter than the bare spring potential, making the magnetic coupled cantilever easier to excite in the random frequency region. It is believed that the experiments show that the ratio of the open circuit peak to peak voltage output and the potential well are closely related.

### Acceleration Thresholds Based Upon Magnet Size

It has been found that by reducing the dimensions of the coupling magnets, the acceleration required to scavenge usable power can be reduced. A smaller diameter magnet decreases the width of the local potential minimum, reducing the acceleration required to surmount the local potential barrier. It has also been found that experimental results are in good agreement with a theoretical model that takes into account the non-linear magnetic restoring force.

### Experimental Setup

Another test set up configured in the manner illustrated above in connection with FIG. 1(a) was constructed. A cantilever was manufactured using commercially available mono-morph piezoelectric discs composed of a 0.09 mm thick PZT layer deposited on a 0.1 mm thick brass shim (APC International, MFT-50T-1.9A1). The disc was cut into an about 13 mm wide by about 50 mm long strip, and clamped at one end to produce an about 46 mm long cantilever. The PZT layer extended about 25 mm along the length of the cantilever, and the remainder was brass only. The proof mass (including the different size of magnets and an additional fixture that held the magnet) weighed about 2.4 gm, while the cantilever itself weighed about 0.8 gm. The disc-shaped rare earth magnet was attached to the vibrating tip of the cantilever beam, while an opposing magnet of the same type was attached directly to the shaker table frame. In all measurements, the shaker table acceleration was recorded throughout the whole scanned spectrum, with the acceleration referred to at the resonant frequency at each scan, and the frequency swept from about 0 to about 30 Hz in 0.25 Hz steps. The opposing magnet fitted at the free end of the cantilever supplied a symmetrical, repulsive force about the balance of the cantilever during vibration.

Referring again to FIG. 1(a), the horizontal separation between the magnets (designated by η) was adjusted according to the sizes and strengths of the magnets used in the experiment. This separation was found to provide the best compensation for the spring force, and was found to make the effective restoring force as small as possible near the equilibrium point.

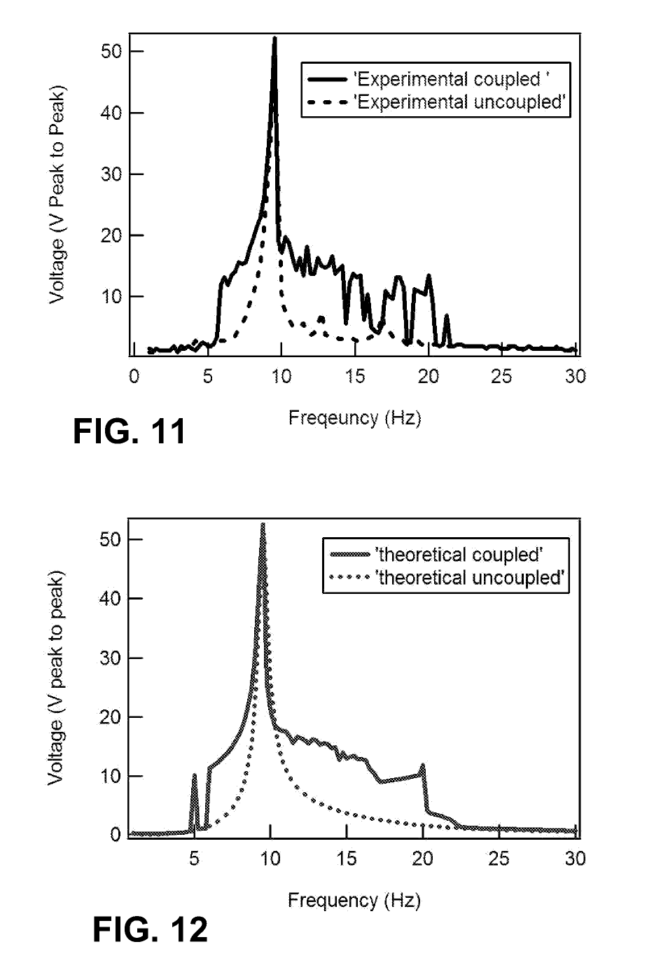

The acceleration to each frequency was subject to the shaker table (Labwork ET-126) response to a constant voltage from a function generator (YOGOGAWA FG300) and amplifier (Labwork Pa-13) that drove the shaker. Details of the acceleration functions were recorded and modeled by 6th order polynomials for accuracy and theoretical comparison. The voltage generated by the piezoelectric cantilever beam was measured directly by a oscilloscope (Agilent 54624A) and the voltage peak to peak was recorded at 10th second of continuous vibration at each frequency. FIG. 11 shows the outputs of the cantilever as a function of shaker table vibration frequency in both coupled and uncoupled cases. As can be seen, the coupled case shows broadening spectrum response than the regular uncoupled cantilever.

### Theoretical Prediction of Spectrum Response

In order to model a solution of the coupled and uncoupled cases in the parametrically excited system, equation (3) below was adopted and was found to produce satisfying results. The mechanical dynamics of the piezoelectric cantilever was modeled by adding a 1-D (z direction) magnetic force Fₘ(z), and a electrically coupled term σV, to a sinusoidal driven force, mA(ω)cos(ωt), in a spring-mass-damping equation.

m\ddot{z}+dż+kz+Fₘ(z)+σV=mA(ω)cos(ωt) (3)

where V is the voltage generated by the cantilever, and σ represents the coupling coefficient, in addition to the mass, m, damping, d, spring constant, k, angular frequency, ω, and acceleration, A, respectively.

The electrical circuit of the cantilever may be completed with the following equation (4):

$$\dot{V} + \frac{1}{{R}_{l} {C}_{l}} V + θ \dot{z} = 0 \qquad ( 4 )$$

where Rₗ is the equivalent resistance, Cₗ is the equivalent capacitance and θ is the piezoelectric coupling coefficient in the measured circuit.

The parameters from the experiments were implemented with the values of m=0.0024 kg, d=0.008 Nsec/m, k=8.55N/m, σ=0.000005, θ=1250 and 1/RₗCₗ=0.01. The acceleration A(f)=A(ω/2π) was a empirical function of frequency from the accelerometer on the shaker and fitted to the 6^{th} order polynomial, which is designated by the acceleration at resonant frequency.

The magnetic force functions in the axial and transverse directions were measured and modeled by using the aforementioned magnetic dipole-dipole equation, where the magnetic field B and potential U can be expressed as

$$\begin{matrix}\hat{B} = \frac{{u}_{0} M cos θ}{2 π {r}^{3}} \hat{{u}_{r}} + \frac{{u}_{0} M sin θ}{4 π {r}^{3}} \hat{{u}_{θ}} & ( 5 ) \\ U = \frac{{u}_{0} {M}^{2}}{2 {πη}^{3}} = \frac{d}{{( {az}^{2} + b {η}^{2} )}^{\frac{3}{2}}} & ( 6 )\end{matrix}$$

Magnetic moments were experimentally determined from the axial forces Fₐₓᵢₐₗ exerted by the two opposite magnets at respective coupling distances, η, from the different pairs of magnets.

$$M ( η , {F}_{axial} ) = {( {F}_{axial} \frac{{η}^{4} 2 π}{3 {u}_{0}} )}^{\frac{1}{2}} \qquad ( 7 )$$

The magnetic force with respect to the deflection of the cantilever was modeled by the following formula:

$$\begin{matrix}{F}_{m} = \frac{- 3 {u}_{0} {M}^{2}}{2 {πη}^{4}} = \frac{- 3 azs}{{( {az}^{2} + b {η}^{2} )}^{\frac{5}{2}}} & ( 8 ) \\ {F}_{axial} = \frac{- 3 {u}_{0} {M}^{2}}{4 {πη}^{4}} = \frac{- 3 b η}{{( {az}^{2} + b {η}^{2} )}^{\frac{5}{2}}} \\ at z = 0 , b = {( \frac{2 π}{{u}_{0} {M}^{2}} )}^{\frac{2}{3}} \\ at η = 0 , a = {( \frac{4 π d}{{u}_{0} {M}^{2}} )}^{\frac{2}{3}} {s}^{- 1} & ( 9 )\end{matrix}$$

where Fₘ, is the magnetic force in the same direction as the cantilever vibrates, and parameters a and b are calculated at the boundary conditions η=0 and z=0, respectively.

The correction factor, s, is the modified factor due to the flexure motion of the cantilever. For 4.8 mm diameter magnet, M_{4.8}=0.011 Am², η_{4.8}=0.0065 m, the fitting variables a_{4.8}=3.104*10⁷, and b_{4.8}=1.145*10⁷. The correction factor, s=0.5858, was applied to the different magnet size coupling since the same cantilever was used.

The formulas (3) and (4) incorporated with the magnetic force function (8) in the coupled case and the uncoupled one is shown in FIG. 12, which matches up well with the experimental result shown in FIG. 11.

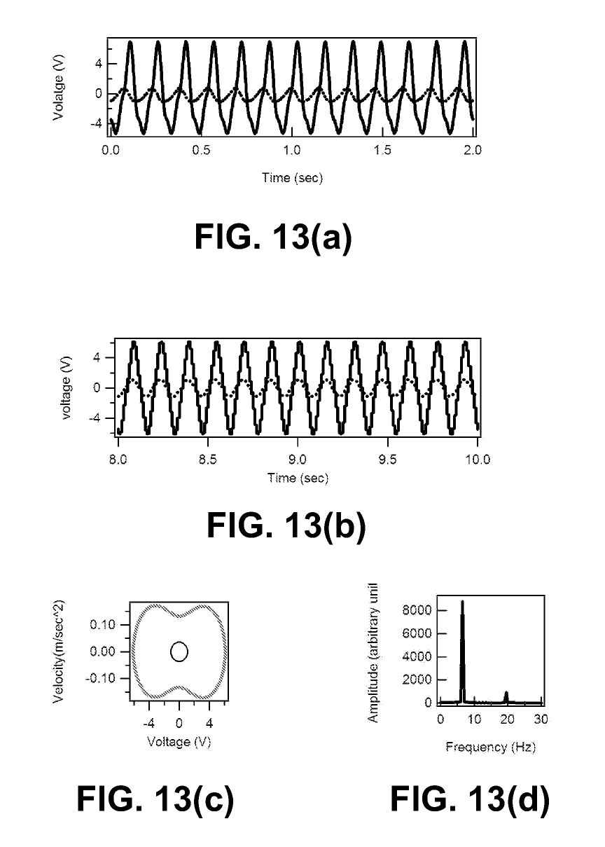

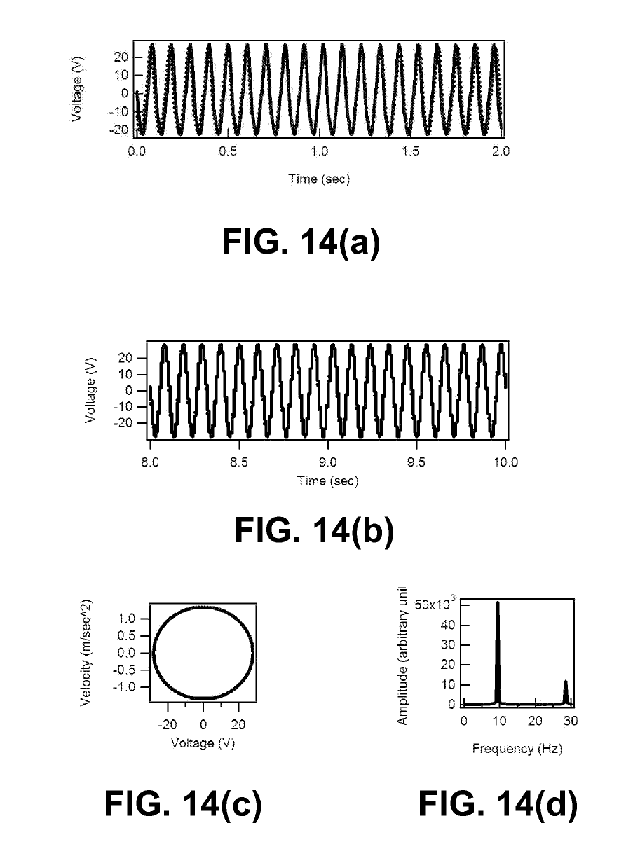

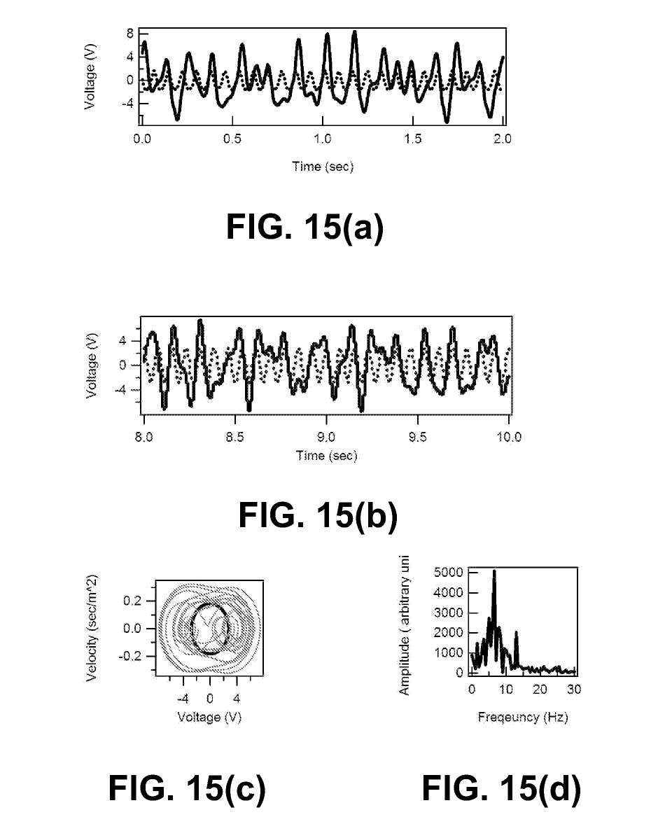

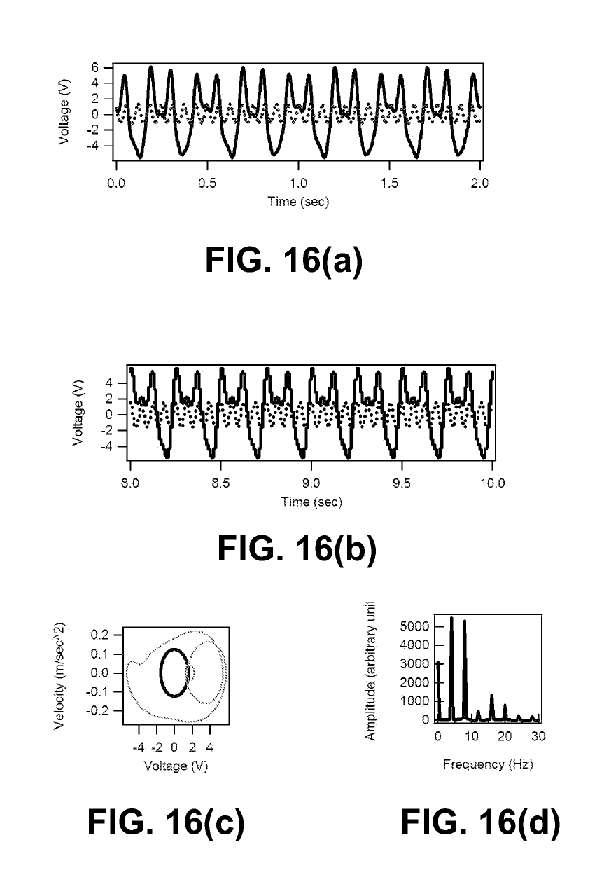

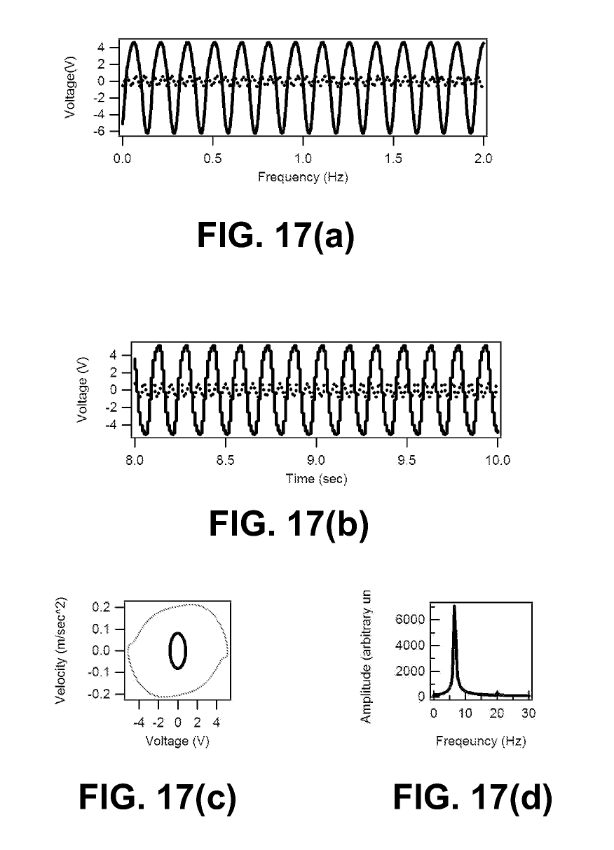

The numerical solution calculated the displacement and voltage output for 10 seconds. The voltage output was taken from the difference between maximum and minimum values (peak to peak) between 8-10 seconds, after the initial transit period. The experimental data were taken at the last 2 seconds of the 10 seconds of vibration at each frequency. Experimental and theoretical calculation for the time domain in different frequency responses, 6.5 Hz, 9.5 Hz, 13 Hz, 16 Hz and 20 Hz, can be seen in FIGS. 13(a)-17(a) (experimental) and FIGS. 13(b)-17(b) (theoretical). The simultaneous solutions to equations (3) and (4) include displacement and voltage output, and the predicted Poincarë plots with voltage and velocity of the cantilever beam are shown in FIGS. 13(c)-17(c). As can be seen, various degrees of chaotic and deterministic chaotic features such as sub-harmonics and ultra-harmonics appear in different frequency responses. FIGS. 13(d)-17(d) show the frequency spectrum analysis of only the coupled cantilevers in response to respective frequency.

The coupled cantilever with non-linear magnetic coupling, similar to a pendulum oscillation, evolves with distance between the coupled magnets and with the frequency into sub-harmonics situation. Overall, four distinctive features of amplifications for energy harvesting from the magnetic coupling that is shown the figures above, were observed. They include the following: (1) pure amplification, in which 6.5 Hz exhibits about 5 times amplitude amplification at same frequency and some component of ultra-harmonic at 19.5 Hz; (2) unit amplification, in which the amplitude at resonant frequency at 9.5 Hz remains as strong; (3) chaotic amplification (13 Hz) that shows amplified amplitudes and broadband spectrum; (4) sub-harmonic amplification (16 Hz and 20 Hz), in which 16 Hz shows amplified amplitude at multiple quarter frequency sub-harmonics and 20 Hz exhibits a 5-fold amplitude amplification at one-third frequency sub-harmonic oscillation. For energy harvesting purposes, the mixtures of all four features above from magnetic coupling enhance the performance of an otherwise regular harvester.

In addition, unlike a typical Duffing equation where external force function is modeled in proportion to z³ in exertion to the mass-spring-damping function, the symmetric force function used herein appears to exhibit no hardening or softening spring process. Consequently, the resonant frequency is believed to be substantially independent of driving frequency, and the amplitude peaks at neither the fundamental resonant nor its sub-harmonic or ultra-harmonic do not appear to be bent.

### Coupling Thresholds and Magnet Sizes

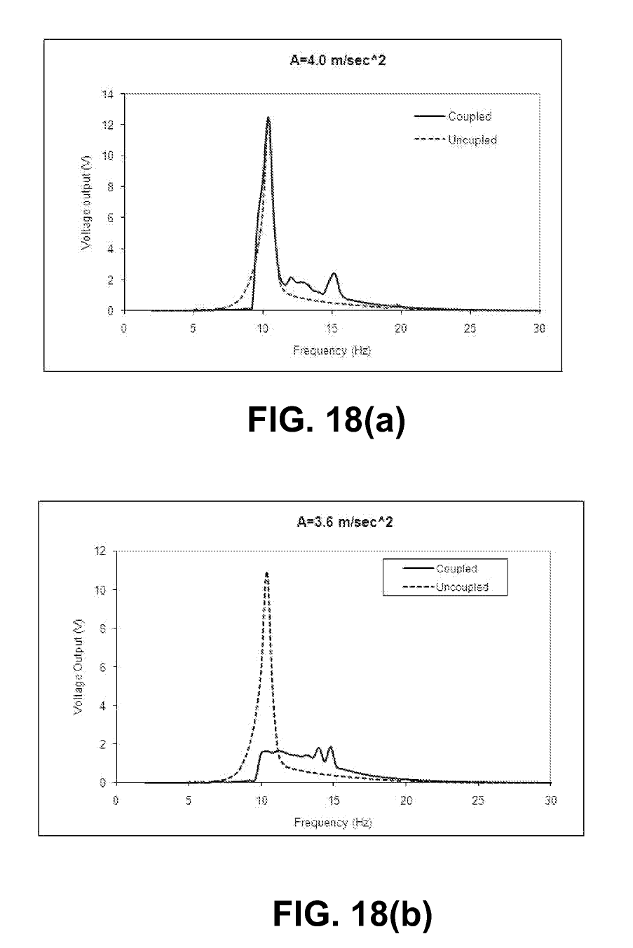

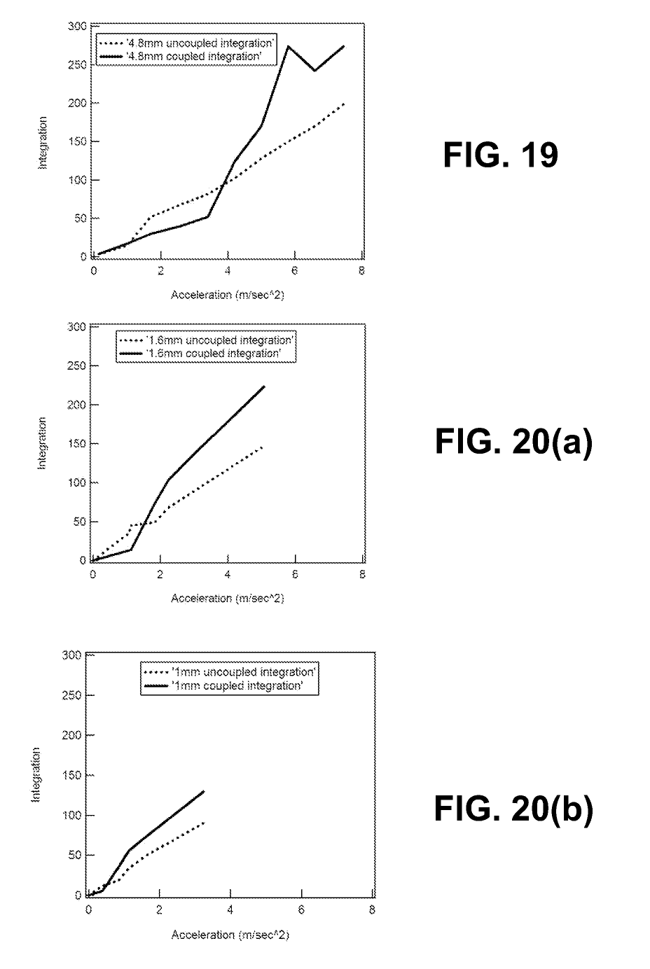

The enhancement of magnetic coupling is believed to only take place when the cantilever is in the combination of the dynamic mixtures of the stochastic states mentioned above. However, the enhanced scheme of magnetic coupling is also limited by the potential well that requires certain acceleration to overcome. Therefore, at the acceleration below the threshold, the barrier becomes insurmountable and otherwise dampens the amplitude of the peak at resonant frequency. FIGS. 18(a) and 18(b) show the magnetic coupling effect at acceleration above its threshold and below its threshold. If one compares the areas under the coupled and uncoupled cases, in different accelerations, one can see the threshold of the acceleration that is needed for the coupling advantages to take place. FIG. 19 shows the comparison of the coupled and uncoupled and indicates that approximately 4 m/sec² is the threshold in this experimental setup.

In reasoning the coupling, it is believed that if the driven force can overcome the barrier, in principle, the cantilever can drift over to the next potential low point, enhancing the voltage output. However, if the potential barrier is too high, it requires higher acceleration. The hypothesis is that least acceleration is required for a flat barrier, if it exists, between the two potential lows. Similarly, if the distance between the potential minima is too large, it needs larger acceleration to at least cover the oscillation amplitude. Therefore, minimizing potential barrier and shortening the distance between the potential minimum are believed to be important. The experimental force function measurements have indicated that when the magnet distance decreases the distance between minima increases, and the barrier height increases as well. However, when the magnet distance becomes too far, not only the potential minima distance increases, but the coupling effects of the barrier become negligible. Therefore, a magnet with smaller diameter fits the prescription of smaller maxima distance and the reasonably barrier height since only the spring force close to the zero potential needs to be conquered and balanced.

Above, a 4.8 mm diameter (Radio Shack model 64-1895) magnet was experimentally tested for the coupling performance. For reducing the acceleration threshold purpose, the magnet diameter was reduced to 1.6 mm (Amazing Magnets model D032-063) and 1.0 mm (Magnet Expert Ltd. Model F4305), while the proof mass remained the same for the cantilever. Similar procedures of experiment as with the 4.8 mm diameter magnet were performed with the 1.6 mm and 1.0 mm diameter magnets. As expected, the acceleration threshold decreased as the magnetic size decreased. FIGS. 20(a) and 20(b) show the acceleration vs. areas in both coupled and uncoupled cases for 1.6 mm and 1.0 mm diameter magnets, respectively.

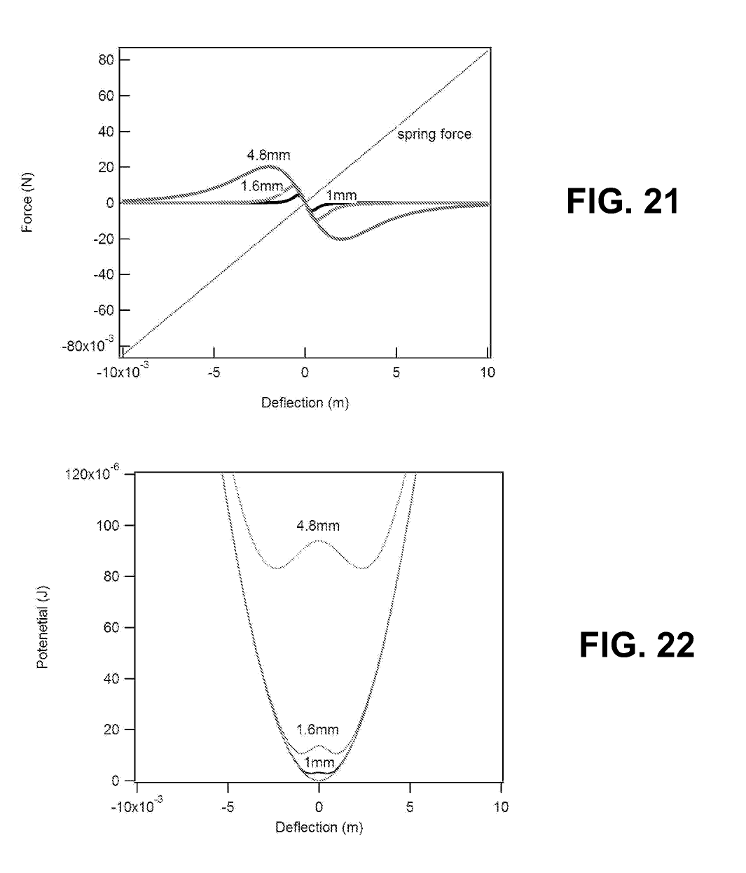

As formulated with the 4.8 mm magnets, the magnetic moments are calculated according to the axial force measured at the coupling distance and then, the magnetic force function was experimentally determined. For the 1.6 mm diameter magnet, M_{1.6}=0.0007408 Am². η_{1.6}=0.002 m, a_{1.6}=1.183*10⁹, b_{1.6}=4.362*10⁸, and for the 1.0 mm diameter magnet, M_{1.0}=0.0001292 Am², η_{1.0}=0.0009 m, a_{1.0}=1.214*10¹⁰, b_{1.0}=4.477*10⁹. FIG. 21 shows the magnetic forces with the fitting curve using the model and FIG. 22 shows the potentials of the three sizes of magnetic force at the critical distances. The coupling distance was determined empirically when the coupling effect takes place. In the experiment with 4.8 mm diameter magnets, for instance, the bifurcation distance was at about 7.5 mm. However it will require significantly higher acceleration for the stochastic effect to take place at the distance shorter than 5 mm. Therefore, 6.5 mm was used as the empirical coupling distance. Similarly, the coupling distances were 1.9 mm and 0.9 mm for the magnets with diameters of 1.6 mm and 1 mm, respectively. However, the potential dip distances for the 3 couplings were 4.6 mm, 2.03 mm and 1.1 mm. The force function extreme points for the 3 couplings were 2.3 mm, 0.9 mm and 0.45 mm. The potential well barriers relative to their own potential dips for the 3 coupling distances were calculated to be about 10.70 μJ, about 4.80 μJ and about 1.68 μJ.

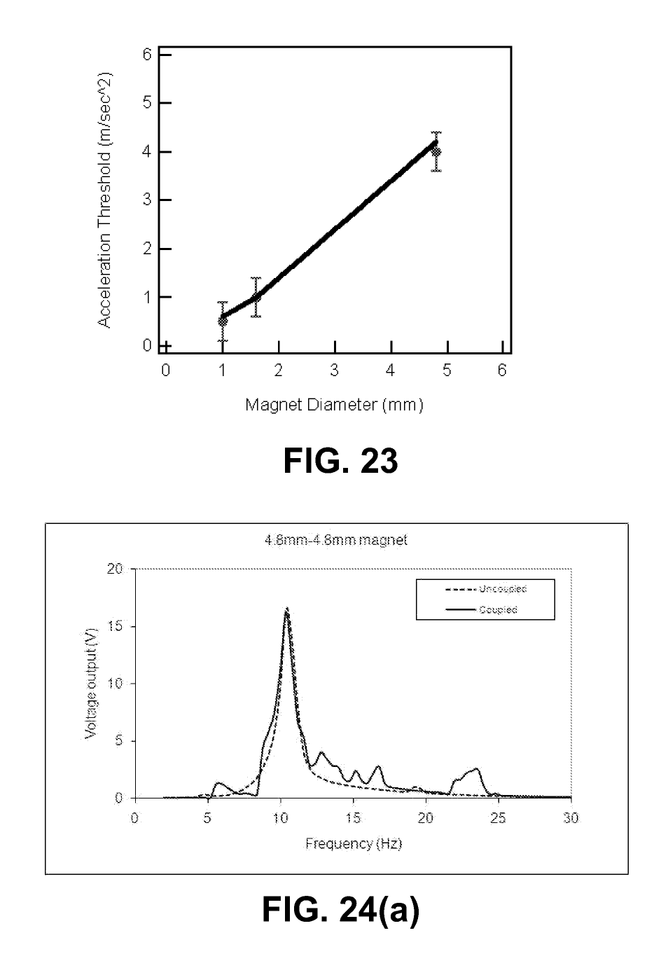

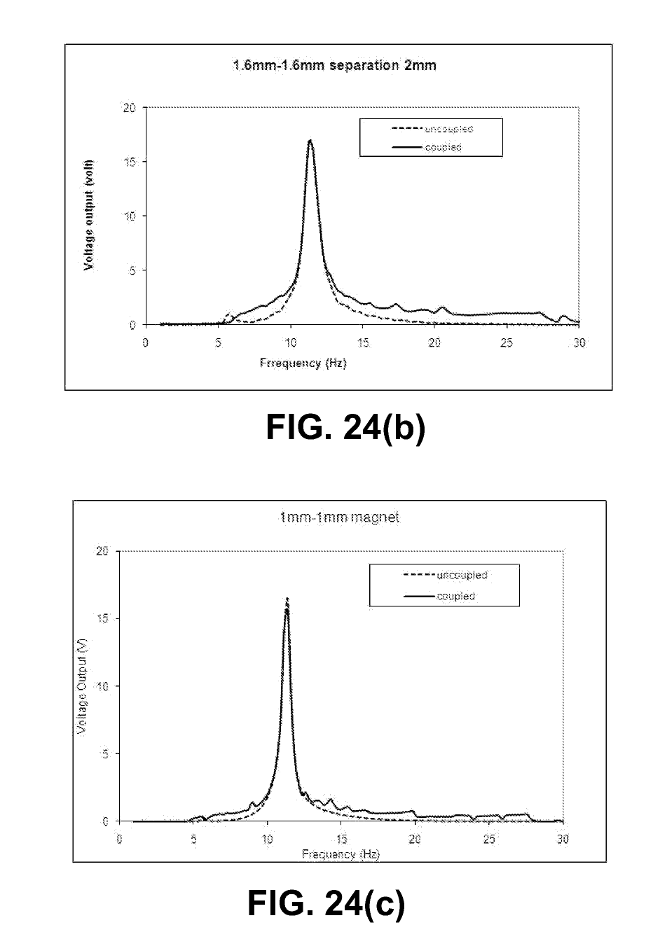

In comparison, as shown in FIG. 23 that by reducing the dimensions of the magnet from 4.8 mm diameter to 1.0 mm in diameter, it decreases the acceleration from about 4 mm/sec² to about 0.6 m/sec², a strong consistency between experimental and theoretical results. The smaller diameter magnet is shown to reduce the width of the local potential minimum produced by the magnetic force, reducing the acceleration requirement. As the barrier is reduced along with the decreasing potential dips, the acceleration is also reduced. The enhanced scheme of magnetic coupling therefore is shown to work when the magnet size is reduced with the lower threshold from the acceleration. In addition, as shown in FIGS. 24(a)-(c), the larger magnets produced a higher output around resonant frequency than the smaller magnets, resulting in narrower frequency responses to the same acceleration.

Therefore, an enhanced coupling is shown to require at least the comparability of the magnetic force and the spring force of the cantilever. In addition, appropriating the potential barrier and minimizing the distance between the potential dips could reduce the driving source acceleration. If the potential barrier is too high, it requires higher acceleration. If the potential barrier is too small, it lacks the stochastic bouncing that amplifies the amplitude. It has also been shown that smaller magnets can be used to harvest low level vibration with the benefit enhanced power output from an energy harvester.

### CONCLUSION

Therefore, the coupling of non-linear force to a linear vibration element as utilized in the embodiments described herein typically improves the responsiveness of the linear vibration element at off resonant frequencies, and typically while retaining substantially the same resonant frequency, without increasing damping at the resonant frequency, and substantially retaining the amplitude at the resonant frequency as compared to when the linear vibration element is uncoupled from the non-linear force. It was also shown that the non-linear magnetic coupling results in the interplay of non-linear dynamics that include pure amplification, unit amplification, sub-harmonic amplification and chaotic amplification in vibrations through Poincarë plots and frequency analysis.

While the present invention has been illustrated by a description of the various embodiments and the examples, and while these embodiments have been described in considerable detail, it is not the intention of the applicants to restrict or in any way limit the scope of the appended claims to such detail. Thus, although embodiments of the invention are illustrated through the accompanying figures, one having ordinary skill in the art will appreciate that additional advantages and modifications may be made without departing from the scope of the present disclosure. For example, although the embodiments discussed herein focus on energy harvesting, it will be appreciated that the concepts described herein may be utilized in other applications, e.g., accelerometers, vibration detectors, and other sensing applications. Thus, additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. An apparatus, comprising:
a vibration element having a resonant frequency, wherein the vibration element is coupled to a non-linear force that improves a response of the vibration element to non-resonant vibrations; and
a circuit coupled to the vibration element and configured to output an electrical signal in response to vibration of the vibration element.

2. The apparatus of claim 1, wherein the non-linear force is applied symmetrically and bi-directionally to the vibration element.

3. The apparatus of claim 1, wherein the vibration element is a linear vibration element.

4. The apparatus of claim 1, wherein the vibration element comprises a cantilever.

5. The apparatus of claim 4, wherein the cantilever comprises a piezoelectric cantilever.

6. The apparatus of claim 4, further comprising first and second permanent magnets configured to subject the cantilever to the non-linear force, wherein the first permanent magnet is disposed proximate a free end of the cantilever, and wherein the second permanent magnet is disposed opposite the first permanent magnet generally along an axis of the cantilever and in a repelling orientation relative to the first permanent magnet.

7. The apparatus of claim 6, wherein the first and second permanent magnets have a coupling threshold that is below an acceleration to which the vibration element is subjected by a source of vibration.

8. The apparatus of claim 6, wherein the second permanent magnet is fixed relative to the cantilever.

9. The apparatus of claim 6, wherein the second permanent magnet is disposed proximate a free end of a second cantilever oriented generally along the axis of the first cantilever.

10. The apparatus of claim 1, wherein the circuit includes an energy scavenging circuit.

11. The apparatus of claim 1, wherein the circuit includes a sensing circuit.

12. The apparatus of claim 1, wherein the coupling of the non-linear force to the vibration element does not substantially alter the resonant frequency of the vibration element.

13. The apparatus of claim 1, wherein the coupling of the non-linear force to the vibration element does not substantially increase damping of the vibration element at the resonant frequency.

14. The apparatus of claim 1, wherein the coupling of the non-linear force to the vibration element does not substantially decrease an amplitude of the vibration element at the resonant frequency.

15. The apparatus of claim 1, wherein the non-linear force introduces at least one sub-harmonic component of the resonant frequency.

16. A method of scavenging energy responsive to a source of vibration, the method comprising:
subjecting a vibration element to the source of vibration, wherein the vibration element has a resonant frequency;
exposing the vibration element to a non-linear force while the vibration element is subjected to the source of vibration to improve a response of the vibration element to non-resonant vibrations generated by the source of vibration; and
generating an electrical signal responsive to vibration of the vibration element.

17. The method of claim 16, wherein the non-linear force is applied symmetrically and bi-directionally to the vibration element.

18. The method of claim 16, wherein the vibration element is a linear vibration element.

19. The method of claim 16, wherein the vibration element comprises a cantilever.

20. The method of claim 19, wherein the cantilever comprises a piezoelectric cantilever.

21. The method of claim 19, wherein exposing the vibration element to the non-linear force is performed by first and second permanent magnets, wherein the first permanent magnet is disposed proximate a free end of the cantilever, and wherein the second permanent magnet is disposed opposite the first permanent magnet generally along an axis of the cantilever and in a repelling orientation relative to the first permanent magnet.

22. The method of claim 21, wherein subjecting the vibration element to the source of vibration includes subjecting the vibration element to an acceleration that is greater than a coupling threshold between the first and second permanent magnets.

23. The method of claim 21, wherein the second permanent magnet is fixed relative to the cantilever.

24. The method of claim 21, wherein the second permanent magnet is disposed proximate a free end of a second cantilever oriented generally along the axis of the first cantilever.

25. The method of claim 16, wherein the coupling of the non-linear force to the vibration element does not substantially alter the resonant frequency of the vibration element.

26. The method of claim 16, wherein the coupling of the non-linear force to the vibration element does not substantially increase damping of the vibration element at the resonant frequency.

27. The method of claim 16, wherein the coupling of the non-linear force to the vibration element does not substantially decrease an amplitude of the vibration element at the resonant frequency.

28. The method of claim 16, wherein the non-linear force introduces at least one sub-harmonic component of the resonant frequency.
